(19) United States
(12) Patent Application Publication
(10) Pub. No.: US 2006/0188699 A1
(43) Pub. Date: Aug. 24, 2006

(54) Protective coating for documents

(75) Inventor: Ruediger Kreuter, Darmstadt (DE)

Correspondence Address: HAMRE, SCHUMANN, MUELLER & LARSON, P.C., P.O. BOX 2902-0902, MINNEAPOLIS, MN, 55402, US

(73) Assignee: DataCard Corporation, Minnetonka, MN (US)

(21) Appl. No.: 10/517,969

(22) PCT Filed: Jun. 13, 2003
(86) PCT No.: PCT/EP03/06249

§ 371 Date: Aug. 10, 2005

(30) Foreign Application Priority Data
Jun. 13, 2002 (DE) 102 26 386.8

(51) Int. Cl. B32B 7/14; B32B 27/36; B32B 9/04; B32B 15/04; B32B 29/00

(52) U.S. Cl. 428/201; 428/532; 428/537.5; 428/447; 428/452; 428/412

(57) ABSTRACT

The invention relates to a protective coating for documents such as a passport, an identification card, or plastic cards such as credit cards, access cards, etc., which is highly resistant to abrasion while having as little influence as possible on the structure of the substrate, i.e. which keeps flexible substrates flexible, and can be applied prior to the document being individualized. The inventive document comprises a flexible or rigid substrate made of a textile material, paper, and/or plastic, particularly film-type or card-type plastic, and a protective coating and is characterized by the fact that said protective coating is less than 0.02 mm thick and is deposited on the substrate particularly from the gas phase and/or plasma phase.

### I. FIELD OF USE

The invention concerns documents such as a pass, an identity card or plastic cards such as for example credit cards, access cards etc.

### II. TECHNICAL BACKGROUND

Documents of that kind comprise a rigid, card-shaped or also flexible substrate.

In regard to the flexible substrates, paper or textile material or plastic material predominates while in regard to rigid substrates plastic material is almost exclusively used, for example Makrolon, polycarbonate, PVC or ABS.

In that case the substrate carries optically perceptible items of information, which are visible for example with the naked eye, in the form of items of written and/or image information on the one hand and/or items of electronically readable information in the form of a magnetic strip or a chip on the other hand.

As documents of that kind are always produced in very large numbers on the one hand the expenditure involved in manufacture is to be kept down while on the other hand it is necessary to afford a level of safeguard against forgery which is as high as possible, that is to say a safeguard against modifying in particular the optically perceptible information.

In addition, by virtue of a service life of in part several years, it is also necessary to achieve adequate wear resistance in regard to the information and readability.

For that purpose the substrates were hitherto frequently laminated, that is to say covered with a layer of transparent plastic material, preferably after the information had been applied to the substrate, that is to say after personalisation of the substrate.

The operation of applying the information was effected either by means of printing or by burning it in by means of a laser, in which respect it was in part also possible for the information to be applied to the substrate through the protective coating when already applied thereto.

A disadvantage in this case is that the protective coating in the form of a laminate is relatively thick, that is to say for example may not also cover a magnetic strip or the contact points for an electronic chip as that impedes the readability thereof, and that generally the lamination operation can be effected only after the document individualisation procedure, that is to say for example producing labelling thereon, so that a multi-stage working procedure becomes necessary.

In addition a protective coating afforded by means of a laminate is very soft and already suffers from relatively severe scratching due to normal use in the course of time. Complete detachment of the laminate due to the protective coating being intentionally or unintentionally pulled off is also possible.

A further disadvantage is the severe electrostatic charging of such laminated documents, which is highly disadvantageous in particular when processing the documents in stacks by machine, for example during production and individualisation, as in that situation a plurality of documents can then be improperly picked up together or transported away.

### III. STATEMENT OF THE INVENTION

a) Technical Object

Therefore the object of the present invention is to provide a protective coating which avoids the disadvantages of the state of the art and which in particular on the one hand is to be extremely abrasion-resistant and which on the other hand influences the structure of the substrate as little as possible, that is to say which also leaves flexible substrates flexible, and which in addition can be applied if possible prior to individualisation of the document.

In addition the invention seeks to provide that a protective coating according to the invention affords additional advantages in use, which are not afforded by a simple lamination procedure.

b) Attainment of the Object

That object is attained by the features of claim 1. Advantageous embodiments are set forth in the appendant claims.

By virtue of the fact that the protective coating is very thin, preferably thinner than 1/50 mm, in particular thinner than 1/500 mm, the mechanical properties of the substrate are not influenced at all thereby.

Textile or film-like materials therefore retain their flexibility, while in the case of rigid substrates such as plastic cards it is possible to provide embossings out of the main plane of the card, as well as perforations or other functional variations in the structure of the substrate.

By virtue of the small thickness of the layer therefore it is possible to cover over a magnetic strip, and same is protected from excessive abrasion without magnetic readability being adversely affected thereby.

With a sufficiently small layer thickness of less than 1/50, in particular less than 1/500 mm, and depending on the material of the coating, electrical contact points on the card for an electronic chip can also be covered by the protective coating as the electrical resistance afforded by the protective coating is insignificant.

In this respect the materials that fall to be considered as the coating are ceramic materials, or carbon coatings, in particular of diamond-like, amorphous carbon, which can additionally be doped with foreign atoms to achieve certain properties, or silicon oxide and/or metal oxides.

By virtue of the small layer thickness, the protective coating remains transparent or at least partially transparent although the material of the coating is an otherwise opaque material.

In spite of the small layer thickness those materials enjoy high resistance to abrasion and thus protect the surface of the substrate and in particular the visible or invisible information applied thereto, that is to say writing, image components, or a magnetic strip, from mechanical damage and destruction.

In this respect, for applying the visible information, it is even possible to have recourse to inexpensively applying the information by means of printing on the substrate if in that case the adhesion of the printing ink with respect to the substrate is deliberately designed to be less than the adhesion of the subsequently applied protective coating with respect to the printing.

If the attempt is made to change the labelling on the substrate, firstly the protective coating has to be removed for that purpose, which at the same time results in removal of the printing.

Additional advantageous properties can be achieved by virtue of a specific configuration and in particular doping of the protective coating.

Thus for example a self-cleaning effect, known as the lotus effect, that is to say a very low degree of adhesion of other materials to the outside surface of the protective coating, can be achieved by attaching fluoride groups for example to silanes or silazanes or other materials which can be used for the protective coating, or also by doping with fluorine.

This on the one hand prevents contamination but—and this is the main purpose—it averts manipulation of the visually visible information on the document by subsequently applying printing to the outside surface of the protective coating as a printing ink would not adhere there or would immediately wipe off again at the slightest contact.

A self-healing effect can also be achieved insofar as scratches or other mechanical damage of small area to the protective coating close up again automatically.

As in particular metal oxides as the protective coating but also other materials which can be considered are also chemically highly resistant then—with a suitable choice for the substrate, for example Makrolon or polycarbonate—the protective coating can also be provided before individualisation of the card with the protective coating and the individualisation procedure can be achieved by introducing electromagnetic radiation into the surface of the substrate through the protective coating, insofar as that electromagnetic radiation—for example laser light—visibly alters the surface of the substrate under the protective coating, while the protective coating remains substantially optically unchanged, that is to say transparent. In that way lettering but also images can be applied to the document after the coating procedure.

It is also possible to envisage optically altering the protective coating itself by means of electromagnetic radiation, in particular laser light, in order to achieve visible alterations and thus lettering or images. Then the visible information is admittedly present in the outermost layer and is no longer protected by an additional protective coating, but that outermost layer itself is so abrasion-resistant that it is possible to forego same.

A further possible form of individualisation provides that the protective coating which has already been applied to the substrate is subsequently altered in terms of its refractive index, for example by acting thereon with electromagnetic radiation such as for example laser light.

As a result the subjacent material appears in a different color to the person viewing it, without that subjacent material, in this case therefore the substrate, having actually experienced a change in color. It is also possible in that way to produce lettering and image information after applying the protective coating, and even in a multi-color configuration, insofar as different variations in the refractive index can be achieved by varying the radiation intensity, the radiation time, the wavelength of the magnetic radiation or other physical factors involved in the irradiation procedure.

The specified protective coatings are produced on the substrate by for example the protective coating being deposited out of the gas or plasma phase in a reaction chamber. In that case the desired properties can be very precisely adjusted by virtue of a specific composition of the gas atmosphere in the reaction chamber. It is also possible to use other coating methods by means of spraying or dipping and printing methods, in particular the ink jet method.

In that way it is possible to coat even those materials which cannot be considered for a printing procedure, that is to say heavily structured and/or highly flexible materials such as for example textile fabrics, non-woven cloths, paper, paper-textile fiber mixes, very thin metal films of less than 1/10 mm thickness etc.

This inherently reduces the risk, in relation to such a document, of removing the originally applied information and replacing it by other information by means of a simple printing method, as firstly printing is already out of the question by virtue of the structure of the substrate and is additionally further prevented by the nature of the protective coating.

In addition such a protective coating of a thickness in the nm-range affords the possibility of making that protective coating visible to the human eye, by virtue of narrow-band excitation, for example by means of UV-C-light, in particular with specific Zu-doping in the protective coating, and thus making selectively visible protective coatings which were applied to the substrate in the form of items of information (labelling or image components) and which are otherwise invisible. This so-called stocks shift effect can be applied in the case of a layer-wise structure of the protective coating in relation to one of the deeper layers of the protective coating, or also only in the form of a single layer of the protective coating, which is then an outer layer, which is nonetheless practicable by virtue of the high resistance to abrasion of the specified materials.

1-11. (canceled)

12. A document comprising:
a flexible or rigid substrate comprising textile material, paper and/or plastic material, in particular plastic material in film form or card form, and
a protective coating, wherein the protective coating is less than 1/50 mm thick and in particular has been deposited on the substrate out of the gas and/or plasma phase.

13. A document as set forth in claim 12 wherein the protective coating has ceramic material, in particular metal oxides, and in particular consists of that material.

14. A document as set forth in claim 12 wherein the coating contains silanes and/or silazanes.

15. A document as set forth in claim 12 wherein the protective coating contains fluoride.

16. A document as set forth in claim 12 wherein at least the outside surface of the protective coating has self-cleaning properties.

17. A document as set forth in claim 12 wherein at least the outside surface of the protective coating has self-healing properties.

18. A document as set forth in claim 12 wherein the refractive index of the protective coating is variable after application to the security document and in particular is irreversibly variable.

19. A document as set forth in claim 12 wherein the refractive index is variable by the action of electromagnetic radiation, in particular light of a given wavelength, in particular by means of laser light.

20. A document as set forth in claim 12 wherein the substrate comprises Makrolon or polycarbonate.

21. A document as set forth in claim 12 wherein the protective coating can be penetrated by electromagnetic radiation, in particular laser light which results in an optical variation in the substrate, without an optical variation in the protective coating.

22. A document as set forth in claim 12 wherein the substrate is provided on the surface with information, in particular labelling and/or image information, and in particular is printed with same, which is between the substrate and the protective coating and the adhesion of the information carriers with respect to the protective coating is greater than with respect to the substrate.
